(19) United States
(12) Patent Application Publication
(10) Pub. No.: US 2025/0052591 A1
(43) Pub. Date: Feb. 13, 2025

(54) SYSTEM AND METHOD FOR DETECTING INFORMATION ABOUT ROAD RELATING TO DIGITAL GEOGRAPHICAL MAP DATA

(71) Applicant: GRABTAXI HOLDINGS PTE. LTD., Singapore (SG)

(72) Inventors: Lam An TRAN, Singapore (SG); Seyed Ali MAJID ZONOOZI, Singapore (SG); Jagannadan VARADARAJAN, Singapore (SG); Wenmiao HU, Singapore (SG); Hannes Martin KRUPPA, Hannover (DE)

(21) Appl. No.: 18/722,852

(22) PCT Filed: Dec. 21, 2022
(86) PCT No.: PCT/SG2022/050920

§ 371 Date: Jun. 21, 2024

(30) Foreign Application Priority Data
Dec. 23, 2021 (SG) 10202114283R

(51) Int. Cl. G01C 21/00; G06T 7/12; G06V 20/56

(52) U.S. Cl. CPC G01C 21/3822; G01C 21/3852; G06T 7/12; G06V 20/588; G06T 2207/20044; G06T 2207/20084

(57) ABSTRACT

According to various embodiments, a system for detecting information about a road relating to digital geographical map data is provided. The system comprises an input device configured to obtain remotely captured geographical image data; and a processor configured to generate ground truth image data from the digital geographical map data, and generate binary image data of the road segments from the remotely captured geographical image data using a semantic segmentation task. The processor is further configured to: skeletonize the binary image data to generate skeletonized binary image data including a center line of each road segment of the road segments, detect a road segment missing from the digital geographical map data using the skeletonized binary image data, detect a road width from the binary image data and the center line of each road segment of the road segments; and detect number of lanes from the detected road width.

### TECHNICAL FIELD

Various embodiments relate to a system and a method for detecting information about a road relating to digital geographical map data.

### BACKGROUND

Obtaining accurate information of the real world and mapping the information may be crucial in many industries providing location-based services. Specifically, in transportation services and ride-hailing services, having accurate road information may allow to provide more precise navigation instructions, resulting in better and smoother driving experience.

Even though an existing crowd-sourced map may allow users to contribute to the map by adding and/or editing map information, there may still be areas which remain unmapped, for example, road segments in rural and sparsely populated areas. Moreover, maps may need to be updated frequently as new information appears in real world, for example, due to constructions of roads. Therefore, more optimized ways of map inference techniques, for example, for detecting information about a road relating to the map, may be required to update map information.

Extracting meaningful information from satellite image data may be helpful for updating the map information. However, it is not straightforward to detect the information about the road relating to the map using the satellite image in an accurate and effective manner, in order to update the map information.

### SUMMARY

According to various embodiments, a system for detecting information about a road relating to digital geographical map data for an area including a plurality of road segments is provided. The system comprises: an input device configured to obtain remotely captured geographical image data for the area; and a processor configured to generate ground truth image data from the digital geographical map data, and generate binary image data of the road segments from the remotely captured geographical image data using a semantic segmentation task, wherein the processor is further configured to: skeletonize the binary image data to generate skeletonized binary image data including a center line of each road segment of the road segments, detect a first road segment missing from the digital geographical map data by converting the skeletonized binary image data to a graph structure of the road segments and comparing the graph structure of the road segments with the ground truth image data, detect a road width of each road segment of the road segments from the binary image data and the center line of each road segment of the road segments; and detect number of lanes of each road segment of the road segments from the detected road width.

In some embodiments, the processor is configured to determine whether a line segment in the graph structure of the road segments is the first road segment missing from the digital geographical map data using a voting algorithm.

In some embodiments, the processor is configured to count number of pixels of the line segment that has a predetermined value, check whether the counted number is greater than a predetermined threshold value, and decide that the line segment is the first road segment missing from the digital geographical map data if the counted number is greater than the predetermined threshold value.

In some embodiments, the processor is configured to enlarge the road segments of the ground truth image data for the voting algorithm.

In some embodiments, the processor is configured to use a polygonal approximation based on the binary image data and the center line of each road segment of the road segments, to detect the road width.

In some embodiments, the processor is configured to train a deep neural network model using the remotely captured geographical image data as an input

In some embodiments, the processor is configured to train the deep neural network model on the ground truth image data generated from the digital geographical map data, and tune the trained deep neural network model with annotated image data.

In some embodiments, the processor is configured to obtain the trained deep neural network model, and use the trained deep neural network model on the semantic segmentation task.

In some embodiments, the road segments include a second road segment which is overlapped by at least one object, and the system further comprises a context module configured to receive additional information, and decide which pixel belongs to the second road segment based on the additional information, to generate the binary image data of the road segments.

In some embodiments, the remotely captured geographical image data includes a satellite image collected by an imaging satellite, and the digital geographical map data includes a crowd-sourced map.

According to various embodiments, a method of detecting information about a road relating to digital geographical map data is provided. The method includes: obtaining remotely captured geographical image data for the area; generating ground truth image data from the digital geographical map data; generating binary image data of the road segments from the remotely captured geographical image data using a semantic segmentation task; skeletonizing the binary image data to generate skeletonized binary image data including a center line of each road segment of the road segments; detecting a first road segment missing from the digital geographical map data by converting the skeletonized binary image data to a graph structure of the road segments and comparing the graph structure of the road segments with the ground truth image data; detecting a road width of each road segment of the road segments from the binary image data and the center line of each road segment of the road segments; and detecting number of lanes of each road segment of the road segments from the detected road width.

In some embodiments, comparing the graph structure of the road segments with the ground truth image data includes: determining whether a line segment in the graph structure of the road segments is the first road segment missing from the digital geographical map data using a voting algorithm.

In some embodiments, determining whether a line segment in the graph structure of the road segments is the first road segment missing from the digital geographical map data includes: counting number of pixels of the line segment that has a predetermined value; checking whether the counted number is greater than a predetermined threshold value; and deciding that the line segment is the first road segment missing from the digital geographical map data if the counted number is greater than the predetermined threshold value.

In some embodiments, determining whether a line segment in the graph structure of the road segments is the first road segment missing from the digital geographical map data further includes: enlarging the road segments of the ground truth image data for the voting algorithm.

In some embodiments, detecting a road width of each road segment of the road segments further includes: using a polygonal approximation based on the binary image data and the center line of each road segment of the road segments.

In some embodiments, the method further includes: training a deep neural network model using the remotely captured geographical image data as an input.

In some embodiments, training a deep neural network model includes: training the deep neural network model on the ground truth image data generated from the digital geographical map data; and tuning the trained deep neural network model with annotated image data.

In some embodiments, generating binary image data of the road segments from the remotely captured geographical image data includes: obtaining the trained deep neural network model; and using the trained deep neural network model on the semantic segmentation task.

In some embodiments, the road segments include a second road segment which is overlapped by at least one object, and generating binary image data of the road segments from the remotely captured geographical image data includes: receiving additional information; and deciding which pixel belongs to the second road segment based on the additional information.

In some embodiments, the remotely captured geographical image data includes a satellite image collected by an imaging satellite, and the digital geographical map data includes a crowd-sourced map.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

The invention will be better understood with reference to the detailed description when considered in conjunction with the non-limiting examples and the accompanying drawings, in which:

FIG. 1 shows a block diagram for a system for detecting information about a road relating to digital geographical map data (for example, missing roads, road width and number of lanes) according to various embodiments.

FIG. 2 shows an exemplary flowchart for a method of detecting information about a road relating to digital geographical map data according to various embodiments.

FIG. 3 shows another exemplary flowchart for a method of detecting information about a road relating to digital geographical map data according to various embodiments.

FIG. 4 shows exemplary views of various input data to train a deep neural network for semantic segmentation according to various embodiments.

FIG. 5 shows an exemplary flowchart for a method of detecting a road segment missing from digital geographical map data according to various embodiments.

FIG. 6 shows exemplary views for a method of detecting a road segment missing from digital geographical map data according to various embodiments.

FIG. 7 shows an exemplary flowchart for a method of detecting a road width in digital geographical map data according to various embodiments.

FIGS. 8 to 10 show exemplary views for a method of detecting a road width in digital geographical map data according to various embodiments.

FIG. 11 shows an exemplary flowchart for a method of detecting number of lanes in digital geographical map data according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of a system and a method are analogously valid for the other system and method. Similarly, embodiments described in the context of a system are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

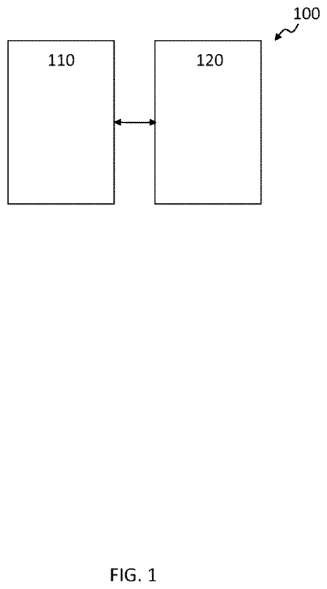

FIG. 1 shows a block diagram for a system 100 for detecting information about a road relating to digital geographical map data (for example, missing roads, road width and number of lanes) according to various embodiments.

The system 100 may be a set of interacting elements. The elements may be, by way of example and not of limitation, one or more mechanical components, one or more electrical components, and/or one or more instructions, for example, encoded in a storage media.

As shown in FIG. 1, the system 100 may include an input device 110 and a processor 120. In some embodiments, the input device 110 and the processor 120 may be mounted on the same device. In some other embodiments, the input device 110 and the processor 120 may be mounted on different devices. The input device 110 and the processor 120 may be capable of data communication.

The input device 110 may obtain remotely captured geographical image data for an area including a plurality of road segments. In some embodiments, the remotely captured geographical image data may include a satellite image (also referred to as a “satellite imagery”) collected by one or more imaging satellites. The satellite image may include images of earth collected by the one or more imaging satellites operated by governments and/or companies. In some other embodiments, the remotely captured geographical image data may include a geo-referenced aerial image (also referred to as an “aerial imagery”).

In some embodiments, the input device 110 may obtain the remotely captured geographical image data via a communication device (not shown). The communication device may allow the system 100 to communicate with a server, a wireless communication system and/or a computing device, in order to transmit and/or receive a signal, e.g. a radio signal. In this manner, the input device 110 may receive the remotely captured geographical image data from the server, the wireless communication system and/or the computing device.

The processor 120 may include a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), etc., or any combination thereof. Any other kind of implementation of the respective functions, which will be described below in further detail, may also be understood as the processor 120.

In accordance with various embodiments, the processor 120 may detect information about a road relating to digital geographical map data (for example, missing roads, road width and number of lanes). The digital geographical map data may contain metadata information such as type of roads, number of lanes, road width, surface, bridge, tunnel, etc. In some embodiments, the digital geographical map data may include a crowd-sourced map. The crowd-sourced map may be a public-driven map under collaborative projects which may allow users to contribute to the map by adding and/or editing information to the map. In accordance with various embodiments, the crowd-sourced map may be used to avoid laborious annotation work and to create a scalable approach towards creating training data. For example, the crowd-sourced map includes an OpenStreetMap (OSM).

In some embodiments, the input device 110 may obtain the digital geographical map data for the area including the road segments. For example, the input device 110 may obtain the digital geographical map data via the communication unit. The input device 110 may receive the digital geographical map data from the server, the wireless communication system and/or the computing device.

In some embodiments, the system 100 may further include a memory (not shown). The memory may be used by the processor 120 to permanently or temporarily store, for example, data to be processed to detect the information about the road relating to the digital geographical map data (for example, missing roads, road width and number of lanes). The memory may store data to train a deep neural network model (as will be described in further detail below). The memory may include, but not be limited to, a cloud memory, a server memory, and a physical storage, for example a RAM (random-access memory), an HDD (hard disk drive), an SSD (solid-state drive), others, or any combinations thereof.

The processor 120 may generate ground truth image data from the digital geographical map data. The ground truth image data of the digital geographical map data may be or include a collection of information at a particular location. A ground truth may refer to a process in which a pixel on the digital geographical map data is compared to what is there in reality in order to verify contents of the pixel on the digital geographical map data. The processor 120 may allow the digital geographical map data to be related to real features and/or materials on a ground, by the ground truth. In some embodiments, the ground truth image data may have value of “0” or “255”.

The processor 120 may generate binary image data of the road segments from the remotely captured geographical image data using a semantic segmentation task. The binary image data may be or include a segmentation mask. The segmentation mask may include an image consisting of binary values, where “1” indicates presence of roads and “0” indicates absence of roads.

The semantic segmentation task may include a task of associating each pixel of the remotely captured geographical image data with a class label of objects. The processor 120 may use the semantic segmentation to generate the binary image data of the road segments, by clustering parts of the remotely captured geographical image data together which belong to the same object class.

In some embodiments, the processor 120 may train the deep neural network model. In some embodiments, the deep neural network model may include three (3) functional blocks including an encoder, a context module and a decoder (not shown). Input images at high resolutions of 1024×1024 may be received to the deep neural network model. The encoder may be pre-trained to classify images of mid-resolutions of 256×256. The road segments from the images of the high resolutions of 1024×1024 may be segmented. Layers of the encoder may be retained to adapt to a different input format. The decoder may include bottleneck blocks, and layers of the decoder up-sample feature size to have symmetric sizes with the layers of the encoder. The bottleneck blocks of the decoder may include a transposed convolutional layer between two convolutional layers with (1×1)-kernels. The decoder may be initialized with random parameters. In the middle of the deep neural network model, there may be a pyramid pooling (PP) module. The PP module may have no parameters.

In some embodiments, the processor 120 may train the deep neural network model using the remotely captured geographical image data as an input. The processor 120 may train the deep neural network model on the ground truth image data (also referred to as “(noisy) pseudo ground truth image data”) generated from the digital geographical map data as a label, and fine-tune again the trained deep neural network model on smaller number of annotated image labels.

In some embodiments, the processor 120 may adopt two-stage transfer learning to train the deep neural network model for robust and well-generalized extraction of the road segments. In the first stage, the processor 120 may train the deep neural network model on the ground truth image data generated from the digital geographical map data, so that the deep neural network model may learn basic visual features and knowledge of a new domain (for example, the remotely captured geographical image data). In the second stage, the processor 120 may transfer learning procedure to fine-tune the trained deep neural network model one more time with well-annotated data of high-quality. In some embodiments, the processor 120 may fine-tune the trained deep neural network model with a standard procedure (for example, referred to as a “gradient descent”) implemented in a framework such PyTorch or Tensorflow. Advantageously, by using the two-stage transfer learning, the system 100 may require less annotated training data for the neural network model to learn to perform the segmentation task.

After the deep neural network model is trained, the processor 120 may obtain the trained deep neural network model, and use the trained deep neural network model on the semantic segmentation task to generate the binary image data of the road segments from the remotely captured geographical image data. At the testing of the trained deep neural network model, the processor 120 may extract the binary image data of the road segments from the remotely captured geographical image data.

The processor 120 may skeletonize the binary image data of the road segments to generate skeletonized binary image data including a center line of each road segment of the road segments. The skeletonization may be an image processing algorithm which may be useful for feature extraction and/or representing an object's topology. The processor 120 may make a topological skeleton of the binary image data of the road segments. The skeletonization may reduce the binary image data of the road segments to one (1) pixel wide representations. The skeletonization may thin the object in the binary image data into lines or curves (e.g. center line of a road segment). The skeletonization may allow to emphasize geometrical and topological properties of a shape including, not limited to, connectivity, topology, length, direction, and width.

In some embodiments, the processor 120 may detect a road segment (referred to as a “first road segment”) missing from the digital geographical map data. The processor 120 may convert the skeletonized binary image data to a graph structure of the road segments. The graph structure of the road segments may include at least one line segment which may represent a road segment. In some embodiments, the conversion may be an ad-hoc process to transform from lines/curves in the binary image into the graph structure, for example, in Python.

The processor 120 may compare the graph structure of the road segments with the ground truth image data to detect the first road segment missing from the digital geographical map data, after obtaining the graph structure of the road segments. Each edge of the graph structure may correspond to the center line of each road segment. In some embodiments, the ground truth image data may contain the center line if the center line belongs to the digital geographical map data. If a road segment is missing from the digital geographical map data, the binary image data of the road segments may contain few pixels or no pixels of the center line.

In some embodiments, the processor 120 may detect the road segments from the remotely captured geographical image data and the digital geographical map data, and deduplicate the detected road segments that already exist in the digital geographical map data in order to flag out at least one first road segment which is missing. In some embodiments, the processor 120 may include two sub-modules (not shown), for example, a first sub-module and a second sub-module. The first sub-module may detect the road segments from the remotely captured geographical image data and the digital geographical map data. The second sub-module may deduplicate the detected road segments that already exist in the digital geographical map data in order to flag out the first road segment which is missing.

In some embodiments, the processor 120 may determine whether the line segment in the graph structure of the road segments is the first road segment missing from the digital geographical map data using a voting algorithm. As an example of the voting algorithm, the processor 120 may count the number of pixels of the line segment that has a predetermined value, for example, “0”. The processor 120 may then check whether the counted number is greater than a predetermined threshold value. The processor 120 may decide that the line segment is the first road segment missing from the digital geographical map data, if the counted number is greater than the predetermined threshold value. The processor 120 may decide that the line segment is not the first road segment missing from the digital geographical map data, if the counted number is equal to or less than the predetermined threshold value.

In some embodiments, the processor 120 may enlarge the road segments of the ground truth image data for the voting algorithm to improve the voting algorithm. For example, the voting algorithm may work better if there is a matching between the ground truth image data and the remotely captured geographical image data.

In some embodiments, the road segments include a road segment (referred to as a “second road segment”) which is overlapped by at least one object. The context module of the deep neural network model may receive additional information. The context module may decide which pixel belongs to the second road segment in the overlapping area which the object, for example, a tree, covers the second road segment based on the additional information, to generate the binary image data of the road segments.

In some embodiments, the processor 120 may use a focal loss function to extract the road segments, to tackle class imbalanced foreground and background sampled bounding boxes in object detection pipelines, for example, a “missing road detection” pipeline. The focal loss function may provide a relatively small training loss compared to other functions such as Binary Cross Entropy (BCE) function and Dice loss function.

In some embodiments, the processor 120 may detect a road width in the digital geographical map data. The processor 120 may estimate the road width automatically from the remotely captured geographical image data for each way ID (unique identifier) (also referred to as “each node ID”) in the digital geographical map data. For example, there may be the way ID, which is the unique identifier, for each road segment in the digital geographical map data. The way ID may be used to identify the road width for all the roads in the digital geographical map data. From the segmentation mask of the road segments obtained, for example, from the “missing road detection” pipeline, the skeleton of the road segments (i.e. the skeletonized binary image data) may be extracted in a similar manner. The skeletonized binary image data may include the center line of each road segment of the road segments. The estimation of the road width may depend on a reliable estimation of a center line (also referred to as a “middle line”) of a road surface and a smoothness of the segmentation mask of the road segments.

In some embodiments, the processor 120 may detect the road width of each road segment of the road segments from the binary image data and the center line of each road segment of the road segments. In some embodiments, the processor 120 may use a polygonal approximation based on the binary image data and the center line of each road segment of the road segments, to detect the road width. In some embodiments, the processor 120 may use a median filtering to detect the road width.

In some embodiments, the processor 120 may detect number of lanes (also referred to as a “lane count”) of each road segment of the road segments in a road designated for traffic flows. The processor 120 may detect the number of lanes from the detected road width. Target roads for such detection may include roads for 4-wheel vehicles to provide the lane count attributes for turn-to-turn navigation software, but not be limited thereto.

In some embodiments, the detection of the number of lanes may be fine-tuned for different road types. In some embodiments, the detected road width may be divided by a default lane width. The result value of this calculation may be a float (i.e. a floating-point number has a decimal place). Thereafter, the result value in the form of the float may be rounded off according to a custom twist function to adapt the number of lanes according to different road types. The result value of this calculation may be an integer (i.e. a number without decimal point) which is considered as the detected lane count.

As described above, the system 100 for detecting the information about the road relating to the digital geographical map data in accordance with various embodiments may enhance the digital geographical map data. The inputs into the system 100 may include the remotely captured geographical image data, and the output from the system 100 may include the missing road segment (i.e. the first road segment) which is compared to the digital geographical map data such as the OSM data, the estimated road width of each road segment, and the number of lanes of each road segment. The system 100 in accordance with various embodiments may utilize algorithms and knowledges in various fields to design and implement the system such as deep learning, computational geometry, computer vision, etc. Furthermore, the system 100 in accordance with various embodiments may be implemented as a batch processing system or a software-as-a-service system.

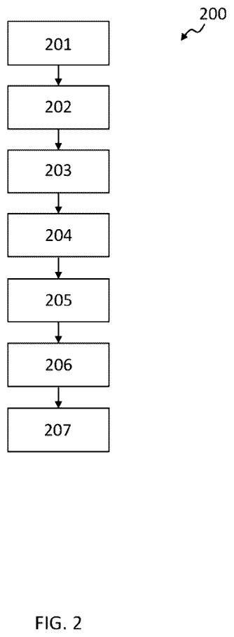

FIG. 2 shows an exemplary flowchart for a method 200 of detecting information about a road relating to digital geographical map data according to various embodiments. According to various embodiments, the method 200 of detecting the information about the road relating to the digital geographical map data for an area including a plurality of road segments may be provided.

In some embodiments, the method 200 may include a step 201 of obtaining remotely captured geographical image data for the area. In some embodiments, the remotely captured geographical image data may include a satellite image (also referred to as a “satellite imagery”) collected by an imaging satellite and/or a geo-referenced aerial image (also referred to as a “aerial imagery”).

In some embodiments, the method 200 may include a step 202 of generating ground truth image data from the digital geographical map data. In some embodiments, a ground truth may be conducted for the digital geographical map data, so that the digital geographical map data is to be related to real features and/or materials on a ground.

In some embodiments, the method 200 may include a step 203 of generating binary image data of the road segments from the remotely captured geographical image data using a semantic segmentation task. In some embodiments, a trained deep neural network model may be obtained, and used on a semantic segmentation task to generate the binary image data of the road segments from the remotely captured geographical image data.

In some embodiments, the method 200 may include a step 204 of skeletonizing the binary image data of the road segments to generate skeletonized binary image data including a center line of each road segment of the road segments. In some embodiments, a topological skeleton of the binary image data of the road segments may be conducted to reduce the binary image data of the road segments to one (1) pixel wide representations.

In some embodiments, the method 200 may include a step 205 of detecting a road segment (referred to as a “first road segment”) missing from the digital geographical map data by converting the skeletonized binary image data to a graph structure of the road segments and comparing the graph structure of the road segments with the ground truth image data. In some embodiments, the graph structure of the road segments may include at least one line segment which may represent a road segment. In some embodiments, a voting algorithm may be used to determine whether a line segment in the graph structure of the road segments is the first road segment missing from the digital geographical map data.

In some embodiments, the method 200 may include a step 206 of detecting a road width of each road segment of the road segments from the binary image data and the center line of each road segment of the road segments. In some embodiments, a polygonal approximation may be used based on the binary image data and the center line of each road segment of the road segments, to detect the road width. In some embodiments, a median filter may be used to detect the road width.

In some embodiments, the method 200 may include a step 207 of detecting number of lanes of each road segment of the road segments from the detected road width. In some embodiments, the detected road width may be divided by a default lane width, and a result value may be rounded off based on road types.

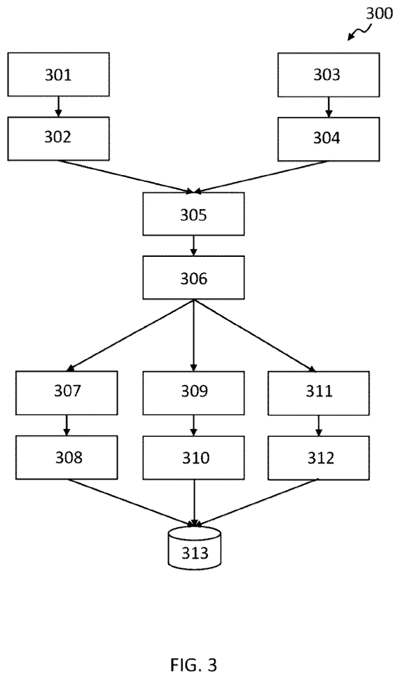

FIG. 3 shows another exemplary flowchart for a method 300 of detecting information about a road relating to digital geographical map data according to various embodiments. According to various embodiments, the method 300 of detecting the information about the road relating to the digital geographical map data may be provided.

In some embodiments, the method 300 may include a step 301 of obtaining digital geographical map data for an area including a plurality of road segments. For example, the digital geographical map data may be referred to as a digital map and may include OSM data.

In some embodiments, the method 300 may include a step 302 of generating ground truth image data from the OSM data. In some embodiments, the method 300 may perform a data transformation of the OSM data to generate the ground truth image data.

In some embodiments, the method 300 may include a step 303 of obtaining remotely captured geographical image data for the area. For example, the remotely captured geographical image data may include a satellite image.

In some embodiments, the method 300 may include a step 304 of generating a satellite image tile. In some embodiments, the method 300 may pre-process the satellite image to generate the satellite image tile. In some embodiments, the satellite image may be cut into overlapping 1024×1024 satellite image tiles.

In some embodiments, the method 300 may include a step 305 of training a deep neural network model. The deep neural network model may be trained on a semantic segmentation task. For example, the deep neural network model may include PP-LinkNet which may be used to improve the semantic segmentation of the satellite image of high resolution with multi-stage training.

In some embodiments, the method 300 may include a step 306 of generating binary image data of the road segments from the satellite image using the trained PP-LinkNet. For example, the binary image data of the road segments may include a segmentation mask of the road segments. In some embodiments, at the testing of the trained PP-LinkNet, the segmentation mask of the road segments may be extracted from the satellite image.

In some embodiments, the method 300 may include a step 307 of operating a “missing road detection” pipeline. For example, the “missing road detection” pipeline may be operated using the segmentation mask of the road segments.

In some embodiments, the method 300 may include a step 308 of outputting at least one missing road segment (referred to as a “first road segment missing from the OSM data”). For example, exact coordinate-based locations for the missing road segment may be output.

In some embodiments, the method 300 may include a step 309 of operating a “road width prediction” pipeline.

In some embodiments, the method 300 may include a step 310 of outputting the road width for each way ID (unique identifier). For example, a meter-based road width for each way ID in the OSM data may be output.

In some embodiments, the method 300 may include a step 311 of operating a “number of lanes” pipeline.

In some embodiments, the method 300 may include a step 312 of outputting the number of lanes for each way ID (unique identifier).

In some embodiments, the method 300 may include a step 313 of updating information about the road, for example, the missing road segment, the road width for each way ID, and the number of lanes for each way ID, in the digital map. In some embodiments, the information about the road may be provided to an operator of the digital map to update the information in the digital map in an efficient and effective manner.

As described above, the method 300 may use two sources of data of the OSM data and the satellite image to update different attributes of the digital map. The system 100 may have the PP-LinkNet to extract the segmentation mask of the road segments. In some embodiments, there may be one or more other systems to detect one or more other attributes from the OSM data, and the PP-LinkNet may be commonly used for the one or more other systems to obtain the segmentation mask of the road segments. The segmentation mask of the road segments may be used to detect the information about the road relating to the OSM data and/or the one or more other attributes.

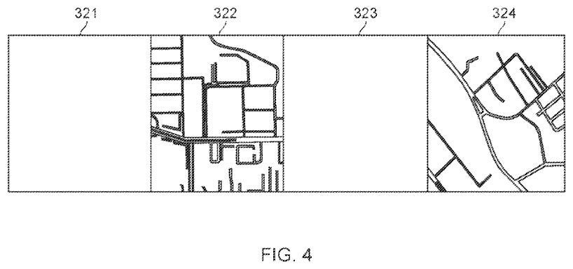

FIG. 4 shows exemplary views of various input data to train a deep neural network for semantic segmentation according to various embodiments.

To extract ground truth image data (also referred to as “(noisy) pseudo ground truth image data”) from digital geographical map data, a rendering process may be used. In some embodiments, a processor 120 of a system 100 may collect remotely captured geographical image data for an area of interest. The processor 120 may render road segments from the digital geographical map data using one or more geographical information system software, for example, TileMill software, QGIS software, ArcGIS software, etc. The rendering process may be referred to as a rasterization process.

As an example of the geographical information system software, the processor 120 may use an open source computer vision library (OpenCV). The processor 120 may draw one or more lines with a predetermined width corresponding to a location of the road segments in the digital geographical map data. For example, the rasterization process may be based on a transformation matrix T available tiff-format of the remotely captured geographical image data, for example, a tiff-format of the satellite image. The rasterization process may be based on a mathematical equation as follows:

$$( lon , lat ) = τ * ( r + 0.5 , c + 0.5 , 1 )$$

where (lon, lat) is longitude and latitude according to image coordinates (c, r).

From the above mathematical equation, given the longitude and the latitude of a node in the road segments of the digital geographical map data, for example, OSM road segments, the processor 120 may infer the image coordinates from an inverse matrix of the transformation matrix T. FIG. 4 illustrates a pair of a satellite image 321 (not shown) and an OSM pseudo ground truth image data 322, and a pair of a satellite image 323 (not shown) and its annotated ground truth image data 324. As shown in FIG. 4, the rasterization process may produce a similar appearance between the rasterized pseudo ground truth image data and the annotated ground truth image data. In some embodiments, the rasterized pseudo ground truth image data may not have pixel-to-pixel matching with road segmentation masks in the annotated ground truth image data.

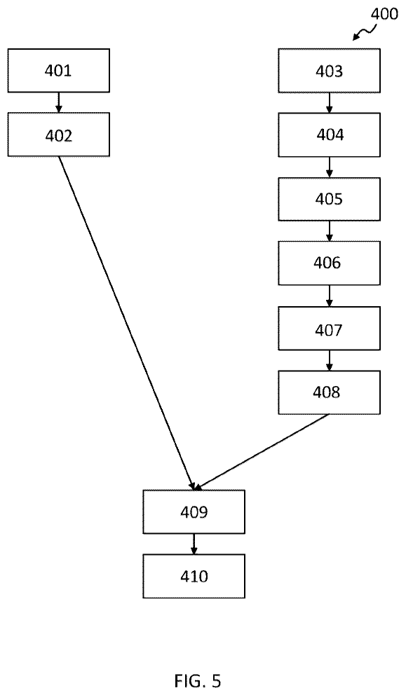

FIG. 5 shows an exemplary flowchart for a method 400 of detecting a road segment missing from digital geographical map data according to various embodiments. According to various embodiments, the method 400 of detecting the road segment missing from the digital geographical map data may be provided.

In some embodiments, the method 400 may include a step 401 of obtaining digital geographical map data. For example, the digital geographical map data may include OSM data.

In some embodiments, the method 400 may include a step 402 of generating ground truth image data from the OSM data. In some embodiments, the method 400 may perform a data transformation of the OSM data to generate the ground truth image data.

In some embodiments, the method 400 may include a step 403 of obtaining remotely captured geographical image data. For example, the remotely captured geographical image data may include a satellite image.

In some embodiments, the method 400 may include a step 404 of generating a satellite image tile. In some embodiments, the method 400 may pre-process the satellite image to generate the satellite image tile.

In some embodiments, the method 400 may include a step 405 of obtaining a trained deep neural network model (for example, see the step 305 of FIG. 3 for training the deep neural network model).

In some embodiments, the method 400 may include a step 406 of generating binary image data of road segments from the satellite image using the trained deep neural network model. For example, the binary image data of the road segments may include a segmentation mask of the road segments. In some embodiments, at the testing of the trained deep neural network model, the segmentation mask of the road segments may be extracted from the satellite image.

In some embodiments, the method 400 may include a step 407 of skeletonizing the segmentation mask of the road segments to generate skeletonized binary image data including a center line of each road segment of the road segments. In some embodiments, a topological skeleton of the segmentation mask of the road segments may be conducted to reduce the segmentation mask of the road segments to one (1) pixel wide representations.

In some embodiments, the method 400 may include a step 408 of converting the skeletonized segmentation mask of the road segments to a graph structure of the road segments. In some embodiments, the graph structure of the road segments may include at least one line segment which may represent a road.

In some embodiments, the method 400 may include a step 409 of using a voting algorithm. The voting algorithm may be used to compare the graph structure of the road segments of the step 408 with the ground truth image data of the step 402 to detect a road segment (referred to as a “first road segment”) missing from the OSM data. In some embodiments, the voting algorithm may be used to determine whether a line segment in the graph structure of the road segments is the first road segment missing from the OSM data.

In some embodiments, the method 400 may include a step 410 of outputting at least one first road segment.

The updated map information in accordance with various embodiments may be stored in a database of a web map service in a cloud. A client application from a device may request the map information in the cloud. Therefore, the device may use the updated map information and may be controlled according to the corrected updated map information.

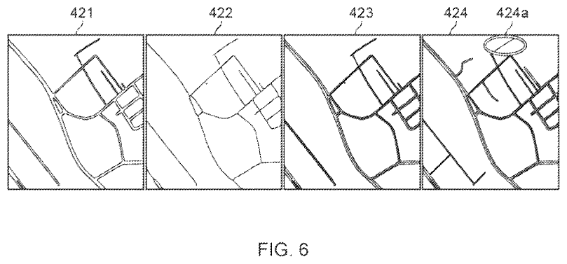

FIG. 6 shows exemplary views for a method of detecting a road segment missing from digital geographical map data according to various embodiments.

The method may include a step of generating binary image data of road segments from remotely captured geographical image data using a semantic segmentation task. An exemplary view 421 of FIG. 6 shows the binary image data of the road segments, for example, a segmentation mask of the road segments.

The method may include a step of skeletonizing the binary image data, to reduce the binary image data to one (1) pixel wide representations. An exemplary view 422 of FIG. 6 shows the skeletonized binary image data of the road segments, for example, a skeleton of the segmentation mask of the road segments, including a center line of each road segment of the road segments.

The method may include a step of converting the skeletonized binary image data to a graph structure of the road segments. An exemplary view 423 of FIG. 6 shows the graph structure of the road segments. As shown in FIG. 6, the graph structure of the road segments may include at least one line segment which may represent a road segment.

The method may include a step of comparing the graph structure of the road segments with the ground truth image data to detect a road segment (referred to as a “first road segment”) missing from the digital geographical map data. An exemplary view 424 of FIG. 6 shows the first road segment (see the circled road segment 424a in the exemplary view 424 of FIG. 6).

In some embodiments, a voting algorithm may be used to determine whether a line segment in the graph structure of the road segments is the first road segment missing from the digital geographical map data. As an example, the voting algorithm may include instructions as follows:

def vote_missing_line_segment(gt_mask, line_segment, threshold):
“gt_mask: image of OSM ground truth mask, has value 0 or 255
line_segment: a line segment in the graph of segmentation mask
represents a road.”
Enlarge gt_mask image by dilation operation.
Count the number of pixels of the line_segment that has value 0.
If the count > threshold, then return TRUE.
Else return FALSE.

As described above, the number of pixels of the line segment that has a predetermined value, for example, “0” may be counted. Thereafter, whether the counted number is greater than a predetermined threshold value may be checked. If the counted number is greater than the predetermined threshold value, it may be decided that the line segment is the first road segment missing from the digital geographical map data. If the counted number is equal to or less than the predetermined threshold value, it may be decided that the line segment is not the first road segment missing from the digital geographical map data. Advantageously, the voting algorithm may provide users to detect the first road segment missing from the digital geographical map data in an effective and efficient manner.

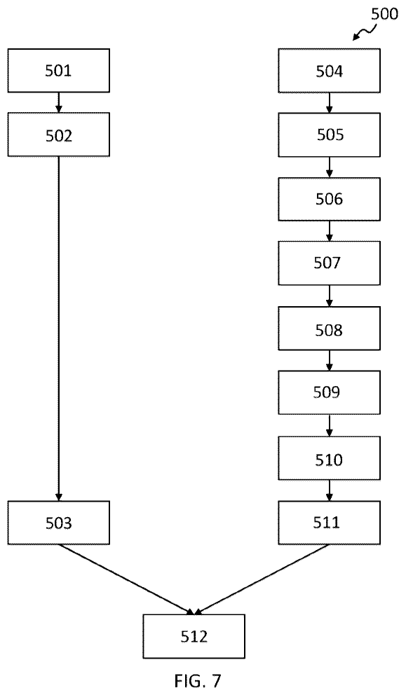

FIG. 7 shows an exemplary flowchart for a method 500 of detecting a road width in digital geographical map data according to various embodiments. According to various embodiments, the method 500 of detecting the road width in the digital geographical map data may be provided.

In some embodiments, the method 500 may include a step 501 of obtaining digital geographical map data. For example, the digital geographical map data may include OSM data.

In some embodiments, the method 500 may include a step 502 of generating ground truth image data from the OSM data. In some embodiments, the method 500 may perform a data transformation of the OSM data to generate the ground truth image data.

In some embodiments, the method 500 may include a step 503 of mapping each way ID (unique identifier) in the OSM data into image coordinates. For example, the image coordinates may refer to pixels in the remotely captured geographical image data, for example, a satellite image, corresponding to a point on the Earth, which has a coordinate (for example, latitude, longitude).

In some embodiments, the method 500 may include a step 504 of obtaining remotely captured geographical image data, for example, the satellite image.

In some embodiments, the method 500 may include a step 505 of generating a satellite image tile. In some embodiments, the method 500 may pre-process the satellite image to generate the satellite image tile.

In some embodiments, the method 500 may include a step 506 of obtaining a trained deep neural network model (for example, see the step 305 of FIG. 3 for training the deep neural network model).

In some embodiments, the method 500 may include a step 507 of generating binary image data of road segments from the satellite image using the trained deep neural network model. For example, the binary image data of the road segments may include a segmentation mask of the road segments. In some embodiments, at the testing of the trained deep neural network model, the segmentation mask of the road segments may be extracted from the satellite image.

In some embodiments, the method 500 may include a step 508 of skeletonizing the segmentation mask of the road segments to generate skeletonized binary image data including a center line of each road segment of the road segments. In some embodiments, a topological skeleton of the segmentation mask of the road segments may be conducted to reduce the segmentation mask of the road segments to one (1) pixel wide representations.

In some embodiments, the method 500 may include a step 509 of estimating bounding polygon of the road segments.

In some embodiments, the method 500 may include a step 510 of estimating the road width from all points in the center line of each road segment of the road segments.

In some embodiments, the method 500 may include a step 511 of outputting the road width of the road segment. For example, the road width may be detected using a median filtering.

In some embodiments, the method 500 may include a step 512 of outputting the road width for each way ID (unique identifier) of the OSM data. For example, the road width for each way ID may be output based on the each way ID mapped into the image coordinates (for example, see the step 503) and the output road width of each road segment (for example, see the step 511).

In some embodiments, the road width may be a significant attribute of the road segments. Knowing the road width may help a map operator tag the number of lanes of the detected missing road segment from the remotely captured geographical image data with less effort. Furthermore, the estimate of the road width may be used to update the “estimated road width” and/or the “the number of lanes” for all way IDs in the digital geographical map data. The road width may be used to check 4-wheeler or 2-wheeler travers-ability.

The updated map information in accordance with various embodiments may be stored in a database of a web map service in a cloud. A client application from a device may request the map information in the cloud. Therefore, the device may use the updated map information and may be controlled according to the corrected updated map information. In some embodiments, the road width may be a significant attribute of the road segments.

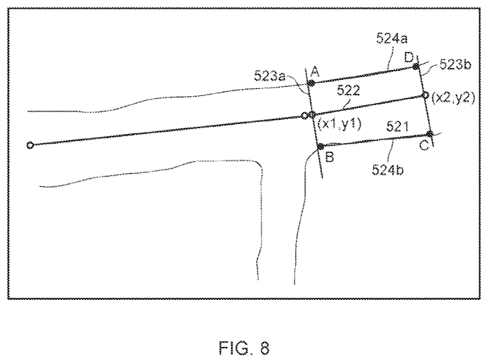

FIGS. 8 to 10 show exemplary views for a method of detecting a road width in digital geographical map data according to various embodiments.

FIG. 8 shows an overview of estimating the road width from the segmentation mask. As shown in FIG. 8, in some embodiments, from a geometrical point of view, perpendicular lines 523a, 523b may be derived to a center line 522 at two (2) endpoints (x1, y1) and (x2, y2). Then, intersections (See “A”, “B”, “C” and “D” in FIG. 8) of the perpendicular lines 523a, 523b with the road boundary 524a, 524b may be estimated. This operation may be performed as a binary structure of segmentation masks of the road segments may be leveraged. The boundary 524a, 524b may be reached if white pixels (non-zeros) of the segmentation mask are not shown anymore.

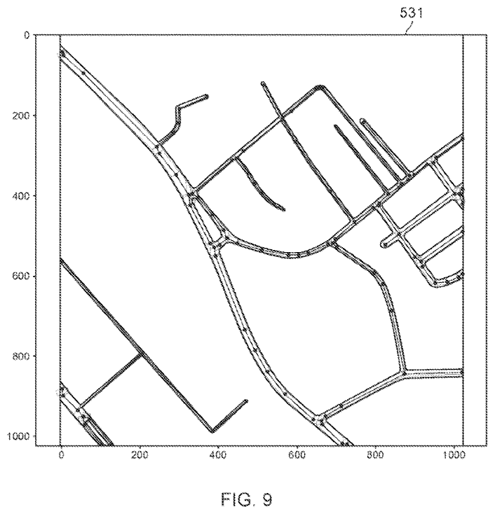

FIG. 9 illustrates an exemplary view 531 showing that polygons cover most of the road segments (As shown in FIG. 9, lines cover most of the road segments). Thus, the result of approximating the road segments with bounding polygons (i.e. the polygonal approximation) may be adequate in terms of coverage.

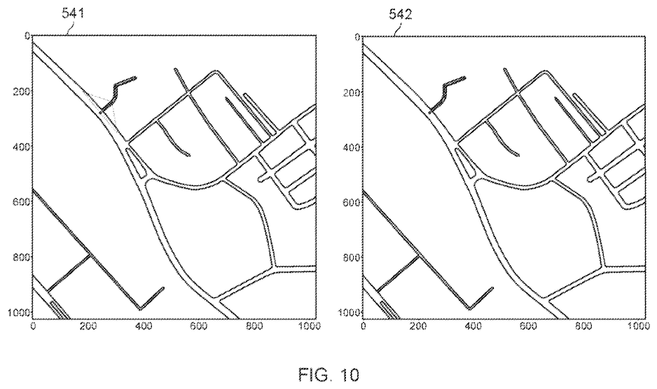

In some embodiments, the approach of estimating the road width from the two (2) points may not be reliable at the line of intersections, since determining the boundary of an unknown road segment may be erroneous. FIG. 10 shows how the estimation of the road width may vary widely (from 3, 4, to 99 pixels) if an endpoint of the line segment is in the intersection. In order to be able to reliably estimate the road width, the road width of each road segment with two (2) endpoints of the center line may not be calculated. The road width for all the points along the center line may be computed, and a median filter may be used to select a final value of the road width from values computed at different points. In some embodiments, the median filter may be more robust to outliers of measurements. FIG. 10 shows that the median filter may roughly rectify errors that have been made in the road width computation at each point along the center line. Furthermore, from the road width in the number of pixels, the real road width of each road segment may be inferred by multiplying the width in terms of pixels with a constant which corresponds to a length of a pixel in real geography. For example, with a known resolution of the remotely captured geographical image data, for example, the satellite image, provided in the affine transformation matrix of the satellite images (e.g. 0.3 m or 0.5 m), the real road width may be estimated accordingly. An exemplary view 541 of FIG. 10 shows the polygonal approximation of the road segments from road width computations with two endpoints. An exemplary view 542 of FIG. 10 shows the polygonal approximation with the median filter on all points along the center line segment.

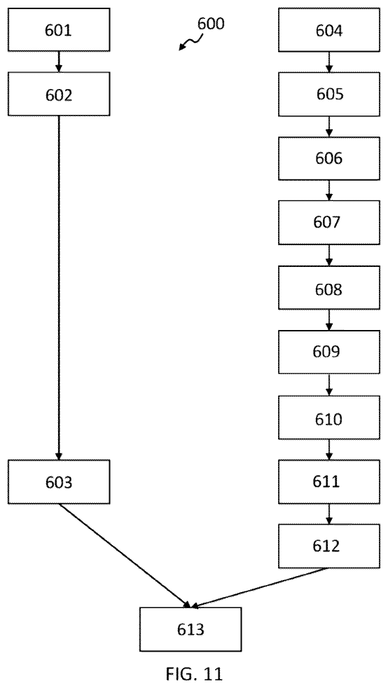

FIG. 11 shows an exemplary flowchart for a method 600 of detecting number of lanes in digital geographical map data according to various embodiments. According to various embodiments, the method 600 of detecting the number of lanes in the digital geographical map data may be provided.

In some embodiments, the method 600 may include a step 601 of obtaining digital geographical map data. For example, the digital geographical map data may include OSM data.

In some embodiments, the method 600 may include a step 602 of generating ground truth image data from the OSM data. In some embodiments, the method 600 may perform a data transformation of the OSM data to generate the ground truth image data.

In some embodiments, the method 600 may include a step 603 of mapping each way ID (unique identifier) in the OSM data into image coordinates.

In some embodiments, the method 600 may include a step 604 of obtaining remotely captured geographical image data. For example, the remotely captured geographical image data may include a satellite image.

In some embodiments, the method 600 may include a step 605 of generating a satellite image tile. In some embodiments, the method 600 may pre-process the satellite image to generate the satellite image tile.

In some embodiments, the method 600 may include a step 606 of obtaining a trained deep neural network model (for example, see the step 305 of FIG. 3 for training the deep neural network model).

In some embodiments, the method 600 may include a step 607 of generating binary image data of road segments from the satellite image using the trained deep neural network model. For example, the binary image data of the road segments may include a segmentation mask of the road segments. In some embodiments, at the testing of the trained deep neural network model, the segmentation mask of the road segments may be extracted from the satellite image.

In some embodiments, the method 600 may include a step 608 of skeletonizing the segmentation mask of the road segments to generate skeletonized binary image data including a center line of each road segment of the road segments. In some embodiments, a topological skeleton of the segmentation mask of the road segments may be conducted to reduce the segmentation mask of the road segments to one (1) pixel wide representations.

In some embodiments, the method 600 may include a step 609 of estimating bounding polygon of the road segments.

In some embodiments, the method 600 may include a step 610 of estimating the road width from all points in the center line of each road segment of the road segments.

In some embodiments, the method 600 may include a step 611 of outputting the road width of the road segment. For example, the road width may be detected using a median filtering.

In some embodiments, the method 600 may include a step 612 of computing the number of lanes of each road segment of the road segments from the detected road width (as described above with FIGS. 7 to 10). For example, the step 612 may include computing the number of lanes with different road types.

In some embodiments, the method 600 may include a step 613 of outputting the number of lanes for each way ID (unique identifier) of the OSM data. For example, the number of lanes for each way ID may be output based on the each way ID mapped into the image coordinates (for example, see the step 603) and the output number of lanes of each road segment (for example, see the step 612).

The updated map information in accordance with various embodiments may be stored in a database of a web map service in a cloud. A client application from a device may request the map information in the cloud. Therefore, the device may use the updated map information and may be controlled according to the corrected updated map information.

In some embodiments, a lane count algorithm may be used to compute the number of lanes. For example, the method of detecting the number of lanes may be fine-tuned for different road types. In some embodiments, the detected road width (as described above with FIGS. 7 to 9) may be divided by a default lane width. The result value of this calculation may be a float. Thereafter, the result value in the form of the float may be rounded off according to a custom twist function to adapt the lane count according to different road types. In some embodiments, the twist function may be a function to customize a prediction for each type of road (for example, motor way, trunk, etc.) The result value of this calculation may be an integer which is considered as the detected lane count. This detection may be performed, for example, by a processor 120 of a system 100 of FIG. 1. As an example, the lane count algorithm may include instructions as follows:

def lane_count_predictor(predicted_road_width, twist_func, lane_width=2.9):
“predicted_road_width: array of predicted road widths for different way_ids
twist_func: a custom twist function to adapt lane account according to different type of
roads (for example, if predicted_lane_count in “motorway” is between [3.8, 4.0], the
lane count for the “motorway” is 4). It is a prior for different road types to do round-off
lane_width: a default lane width”
num_lanes = Divided the predicted lane width to the lane_width # (results in float)
num_lanes = twist_func(num_lanes) # (results in integer)
return num_lanes

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A system for detecting information about a road relating to digital geographical map data for an area including a plurality of road segments, the system comprising:
an input device configured to obtain remotely captured geographical image data for the area; and
a processor configured to generate ground truth image data from the digital geographical map data, and generate binary image data of the road segments from the remotely captured geographical image data using a semantic segmentation task,
wherein the processor is further configured to:
skeletonize the binary image data to generate skeletonized binary image data including a center line of each road segment of the road segments,
detect a first road segment missing from the digital geographical map data by converting the skeletonized binary image data to a graph structure of the road segments and comparing the graph structure of the road segments with the ground truth image data,
detect a road width of each road segment of the road segments from the binary image data and the center line of each road segment of the road segments; and
detect number of lanes of each road segment of the road segments from the detected road width.

2. The system according to claim 1, wherein the processor is configured to determine whether a line segment in the graph structure of the road segments is the first road segment missing from the digital geographical map data using a voting algorithm.

3. The system according to claim 2, wherein the processor is configured to count number of pixels of the line segment that has a predetermined value, check whether the counted number is greater than a predetermined threshold value, and decide that the line segment is the first road segment missing from the digital geographical map data if the counted number is greater than the predetermined threshold value.

4. The system according to claim 1, wherein the processor is configured to use a polygonal approximation based on the binary image data and the center line of each road segment of the road segments, to detect the road width.

5. The system according to claim 1 wherein the processor is configured to train a deep neural network model using the remotely captured geographical image data as an input.

6. The system according to claim 5, wherein the processor is configured to train the deep neural network model on the ground truth image data generated from the digital geographical map data, and tune the trained deep neural network model with annotated image data.

7. The system according to claim 5, wherein the processor is configured to obtain the trained deep neural network model, and use the trained deep neural network model on the semantic segmentation task.

8. The system according to claim 1, wherein the road segments include a second road segment which is overlapped by at least one object, and the system further comprises a context module configured to receive additional information, and decide which pixel belongs to the second road segment based on the additional information, to generate the binary image data of the road segments.

9. The system according to claim 1, wherein the remotely captured geographical image data includes a satellite image collected by an imaging satellite, and the digital geographical map data includes a crowd-sourced map.

10. A method of detecting information about a road relating to digital geographical map data for an area including a plurality of road segments, the method comprising:
obtaining remotely captured geographical image data for the area;
generating ground truth image data from the digital geographical map data: generating binary image data of the road segments from the remotely captured geographical image data using a semantic segmentation task;
skeletonizing the binary image data to generate skeletonized binary image data including a center line of each road segment of the road segments;
detecting a first road segment missing from the digital geographical map data by converting the skeletonized binary image data to a graph structure of the road segments and comparing the graph structure of the road segments with the ground truth image data;
detecting a road width of each road segment of the road segments from the binary image data and the center line of each road segment of the road segments; and
detecting number of lanes of each road segment of the road segments from the detected road width.

11. The method according to claim 10, wherein comparing the graph structure of the road segments with the ground truth image data comprises: determining whether a line segment in the graph structure of the road segments is the first road segment missing from the digital geographical map data using a voting algorithm.

12. The method according to claim 11, wherein determining whether a line segment in the graph structure of the road segments is the first road segment missing from the digital geographical map data comprises:
counting number of pixels of the line segment that has a predetermined value: checking whether the counted number is greater than a predetermined threshold value; and
deciding that the line segment is the first road segment missing from the digital geographical map data if the counted number is greater than the predetermined threshold value.

13. The method according to claim 10, wherein detecting a road width of each road segment of the road segments further comprises: using a polygonal approximation based on the binary image data and the center line of each road segment of the road segments.

14. The method according to claim 10 further comprising: training a deep neural network model using the remotely captured geographical image data as an input.

15. The method according to claim 14, wherein training a deep neural network model comprises:
training the deep neural network model on the ground truth image data generated from the digital geographical map data; and
tuning the trained deep neural network model with annotated image data.

16. The method according to claim 14, wherein generating binary image data of the road segments from the remotely captured geographical image data comprises:
obtaining the trained deep neural network model; and
using the trained deep neural network model on the semantic segmentation task.

17. The method according to claim 10, wherein the road segments include a second road segment which is overlapped by at least one object, and generating binary image data of the road segments from the remotely captured geographical image data comprises: receiving additional information; and
deciding which pixel belongs to the second road segment based on the additional information.

18. The method according to claim 10, wherein the remotely captured geographical image data includes a satellite image collected by an imaging satellite, and the digital geographical map data includes a crowd-sourced map.

19. A data processing apparatus configured to perform the method of claim 10.

20. A computer program element comprising program instructions, which, when executed by one or more processors, cause the one or more processors to perform the method of claim 10.
